(19) United States
(12) Patent Application Publication
(10) Pub. No.: US 2002/0038504 A1
(43) Pub. Date: Apr. 4, 2002

(54) Method of and apparatus for mechanical joining

(76) Inventors: MARKUS ENGLER, ZIZERS (CH); DOMINIK SCHNEIDER, CHUR (CH)

Correspondence Address: JAMES M HESLIN, TWO EMBARCADERO CENTER, 8TH FLOOR, SAN FRANCISCO, CA, 941113834

(21) Appl. No.: 09/331,509

(22) PCT Filed: Oct. 14, 1998
(86) PCT No.: PCT/EP98/06507

(30) Foreign Application Priority Data
Oct. 25, 1997 (DE) DE 19747267.2

(51) Int. Cl. B23P 11/00

(52) U.S. Cl. 29/521; 29/283.5

(57) ABSTRACT

A mechanical assembly process and device for sheet metal parts (30) are disclosed. The material of the metal sheets is displaced and upset out of a sheet metal plane by a forming energy applied by means of a tool set comprising at least one male die (6) and a female mould (4) fitted with an anvil. The forming energy is generated by impact in the form of short, successive strikes.

The invention relates to a method of, and an apparatus for, mechanically joining sheet-metal parts according to the preambles of Claims 1 and 15, respectively.

In the case of mechanical joining by means of deformation, small three-dimensional formations are formed on sheet-metal parts, which are to be connected at connecting locations, under the action of tool sets, which each comprise a punch and die, said three-dimensional formations being the joining elements. These joining elements are formed in that, in a joining region, the sheet-metal material of the sheet-metal parts, which lie flat one upon the other, is jointly displaced out of the sheet-metal plane and upset. This results, from a design point of view, in non-releasable joining elements produced by mechanical joining. For this purpose, a volume region can be either pressed out or forced through from the sheet-metal parts and then deformed by upsetting, with the result that its width increases. This is also referred to as clinching. In order to increase the load-bearing force of such a joining element, it is possible for auxiliary joining parts in the form of punch rivets to be incorporated in the joining element during the joining operation. The individual sheet-metal thicknesses are usually in the range between 0.5 and 3 mm.

The deformation energy which is to be applied for these mechanical joining operations is applied by in each case one press stroke, which provides the necessary pressing forces as joining forces. Depending on the type of material and thickness of the sheet-metal parts which are to be connected, the pressing forces are usually in the range between 20 and 100 kN.

A joining tool which can be used for this purpose is known, for example, from EP-B-77932. In this document, a joining region is bounded by a press-driven punch and a stationary die. If the punch is moved in the direction of the die, the material of the metal sheets is deep-drawn into a cavity of the die. If the die-side metal sheet reaches the base of the cavity, which is formed by an anvil, and if the pressure on the punch is maintained or increased, the base of the press-joined joining section may spread out laterally since the material is upset and the walls which bound the die cavity laterally yield. An advantage of such joining tools is that both the press-joining and the upsetting of the sheet-metal material can take place by means of a single press stroke. For this purpose, however, it has to be ensured that the elements which define the side walls of the die cavity, on the one hand, have a high strength, in order to serve as abutment during the press-joining operation, but, on the other hand, are sufficiently flexible in order to be able to yield during the upsetting operation. If the two functions are distributed over separate elements, the die configuration involves higher outlay.

As has already been explained, depending on the material properties and thickness of the sheet-metal parts, high deformation energy has to be applied. Consequently, the presses have to absorb high forces and therefore have to be of solid design. Likewise, heavy presses are necessary if, for example, a plurality of punch and die sets are installed in order to produce a plurality of joining connections in one press stroke.

In the case of individual joining apparatuses, the die is usually positioned in a stationary manner in one leg of a C-shaped bracket of a tong arrangement, or of an analogous apparatus, the other leg of said bracket having a guide for a punch. For a punch drive, use is then made of a hydraulic working cylinder or else of a pneumatic cylinder or of an eccentric press, the slide of which acts on the punch, while the reaction forces are led away into the C-bracket via a cylinder body. For the stroke, either a force-limiting means or a displacement-limiting means is provided. The necessary pressures of the hydraulic medium are in the order of magnitude of from a multiple of 10 bar up to 500 bar. Associated supply and discharge hose lines are correspondingly inflexible, solid and heavy.

For the reasons outlined above, mechanical joining remains out of the question for certain application areas, for which this joining method would nevertheless be particularly suitable. For example, the abovedescribed joining units with their hydraulic hoses are frequently too heavy and immobile for use on quick-operating robots, for example, in the motor-vehicle industry. A further example is constituted by house structures in the USA in particular, where the conventional wooden frame works are replaced by frameworks made of steel profiles, in the case of which it would be desirable for these to be joined together by the building owner himself/herself. The weight of the conventional joining units, the lack of flexibility of the lines and the small projecting tool length render said joining units extremely impractical for such purposes.

The object of the invention is thus to provide a method which is intended for the mechanical joining according to the preamble of Claim 1 and makes it possible to use lightweight and, taking account of the costs of the drive assemblies as well, inexpensive units.

This object is achieved according to the invention in that the deformation energy is produced by impact stressing in the form of a series of blows of short duration.

For this purpose, an accelerated striking mass transmits a plurality of impulses which, as blows, result in impact stressing. The energy which is fed in each individual step has to be sufficient in order for the material, passing through the elastic region of the characteristic deformation curve into the plastic region, to be deformed. In order to exploit the advantages of the method according to the invention to the full, it is preferred here if this minimum energy is not far exceeded. All the individual blows of a mechanical joining operation together then give the desired joining element, which is thus produced in partial steps.

The minimum energy for each individual step is surprisingly low and thus makes it possible to provide small, lightweight and inexpensive joining units even for the purpose of joining steel sheets of twice 0.5 mm and above. Since the respective reaction forces likewise have to be absorbed in each individual step, it is also possible to use relatively lightweight C-brackets or analogous mounts.

It has proven successful to execute the energy feed for each individual step in that a mass which is arranged in a moveable manner at a distance from the punch is accelerated and strikes the punch, it being the case that the kinetic energy stored in it is transmitted to the punch. The number of individual steps necessary then depends on the size of the mass and its striking velocity, that is to say on the impulse transmitted to the punch. Since the striking mass may be some orders of magnitude higher than the mass of the punch and of the parts connected thereto, more or less the entire impulse is transmitted to the punch. It is recommended here for a relatively large mass to be arranged on the opposite side, that is to say behind the die, in order to absorb the reaction forces. A C-bracket or other mounts then serves/serve, in particular, for guiding the punch relative to the die and may be of correspondingly lightweight construction. Alternatively, of course, it is also possible for the die to be designed such that it can be disposed with respect to the punch, with the result that the striking mass acts on the die, which then transmits impact stressing.

Advantageous details on the number of blows, the duration of the blows and the series of blows are given in the subclaims.

There are numerous possible ways of accelerating a striking mass. One possibility, which may be mentioned by way of example, is constituted by a free-floating piston, of which the two sides are subjected alternately and in quick succession to the action of compressed air. It is also possible to provide an unbalanced-mass vibratory drive in the manner of compacting machines. Furthermore, it is possible to prestress a striker spring by means of a lifting magnet or else to shoot a mass against the punch by means of an explosive charge.

An apparatus according to the invention for joining by means of individual blows is specified in Claim 15.

Further configurations of the invention can be gathered from the subclaims and from the following description.

The invention is explained in more detail hereinbelow with reference to exemplary embodiments illustrated in the attached drawings, in which:

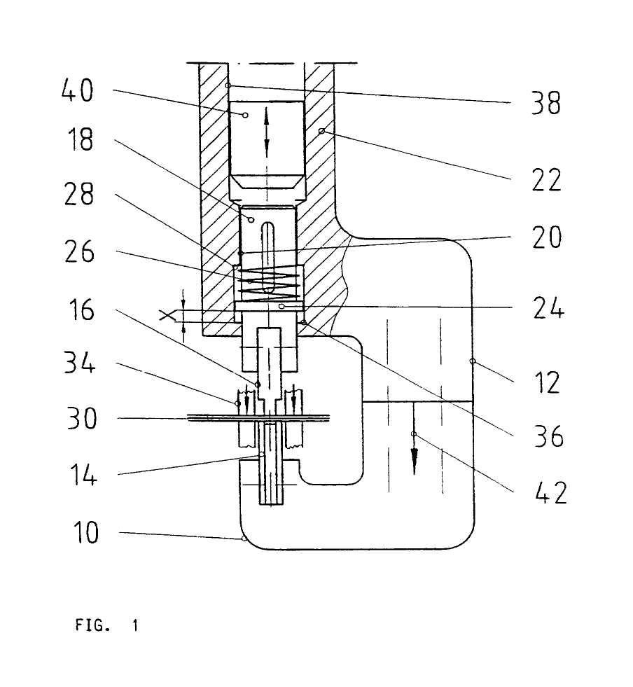

FIG. 1 shows a largely schematic side view, partially in section, of a first exemplary embodiment of a joining unit by means of which the method according to the invention can be implemented, and

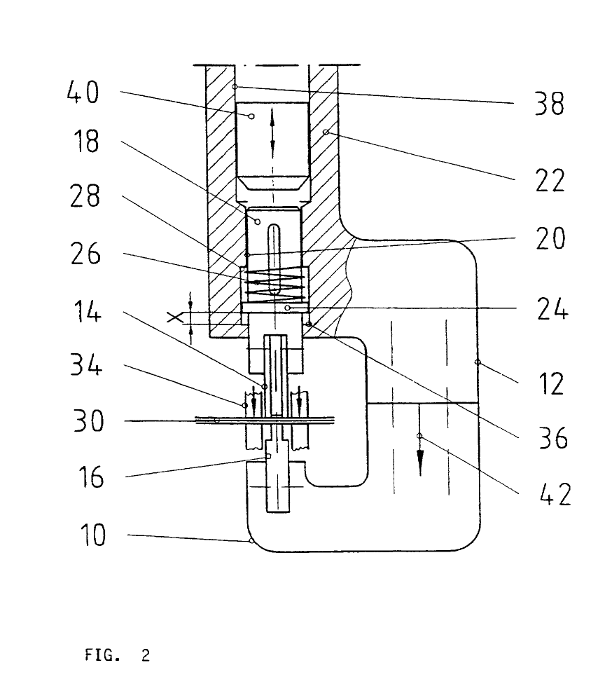

FIG. 2 shows a largely schematic side view, partially in section, of a second exemplary embodiment of a joining unit by means of which the method according to the invention can be implemented.

FIG. 1 shows a joining unit which is intended for mechanical joining by means of deformation and has a bottom leg 10 which belongs to a C-bracket 12 and in which a die 14 of a joining-tool set is clamped. The joining-tool set further comprises a punch 16. The die 14 and the punch 16 are constructed in the manner disclosed, for example, in the abovementioned EP-B-77932. The punch 16 is fastened on a guide piston 18 which is guided rectilinearly in a bore 20 of an extension 22 of the C-bracket 12 and is secured against rotation. The piston 18 has a collar 24, and a spring 26 is clamped in between the collar 24 and a shoulder 28, said spring forcing the guide piston 18 in the direction of the die 14. In the initial position illustrated here, the punch 16 thus has its active face held or prestressed in abutment against the workpieces which are to be joined, in order to prevent the punch 16 from being lifted off from the sheet-metal parts 30 in an initial phase of the joining operation.

Metal sheets 30 which are to be joined rest on a supporting element 32, which is illustrated in a broken-away state, and are secured in the joining position by a clamping holder 34, which can preferably be advanced up to said metal sheets and is likewise illustrated in a broken-away state. The metal sheets 30 which are to be joined are constituted by at least two metal sheets lying one upon the other, and it is frequently the case that more than two metal sheets 30 are connected by punctiform joining elements. The joining operation is executed with a displacement-limiting means, e.g. pneumatic pressure deactivation, in order to interrupt or terminate a series of blows, as is explained hereinbelow. The necessary, sufficient joining displacement “X” is constituted by the distance between the collar 24 and a stop flange 36. In the case of other embodiments, it is also possible for the joining displacement to be adjustable.

In continuation of its bore 20, the extension 22 has a rectilinear guide bore 38 for a striking mass 40. The striking mass 40 is driven, in the arrow direction, to execute a reciprocating movement relative to the guide piston 18. The striking mass 40 is formed here by a free-floating piston, of which the two sides are subjected alternatively and in quick succession to the action of compressed air. Supply and discharge compressed-air lines are not illustrated, since they may be fitted in a known manner. The striking mass 40 strikes against the guide piston 18, which transmits the blow to the punch 16 in each case. The punch 16 thus becomes a striking tool, which introduces impact stressing into the metal sheets 30. A series of individual blows is produced by the alternating action to which the striking mass 40 is subjected, in order for joining to take place over the joining displacement “X” by impact stressing. The impact energy of the individual blows results in the punch 16 executing a single joining operation in partial joining sections in each case, it being the case that each individual blow moves the punch 16, out of a previously assumed partial joining position, further towards the die 14 until the joining operation has been completed.

The number of blows preferably amounts to from 10 to 50 blows, in particular 10 to 25 blows, per second. The number of blows is dependent, in particular, on the type of material of the metal sheets, i.e. aluminium, steel, high-strength steel, etc., and on the sheet-metal thickness. In order to interrupt or to terminate a series of blows once the joining displacement “X”, including upsetting, has been completed, the above-mentioned displacement-limiting means may be provided.

The impact stressing, caused by the striking mass 40, to which the metal sheets 30 are subjected in the form of a series of blows, are blows of short duration which are preferably produced in quick succession. The duration of one blow is preferably selected to be in the range between 0.02 and 5 ms, in particular from 0.1 to 0.9 ms. The short duration of the blow is intended essentially to prevent the inertia of a counteracting mass, which is assigned to the moving striking mass 40 and in this case is the bottom leg 10, from being overcome. A customary joining duration may then be under one second with a series of, for example, from 4 to 10 individual blows during mechanical joining of aluminium sheets 30 with sheet-metal thicknesses of 1 mm in each case.

In the base of the C-shaped frame 12, an arrow 42 indicates that it is possible to adjust the width of the opening of the bracket, for example in order to guide the bracket over a bent section behind which the joining operation is to be carried out.

The clamping holder may serve at the same time as a stripper for stripping the joined metal sheets 30 from the punch 16. The conventional spring-prestressed, die-side strippers are less suitable here since they would slow down the impulse transmission from the striking mass 40 to the guide piston. It would be possible to use lever-like, if appropriate manually operable strippers, although for the sake of simplicity of the illustration, these have not been depicted.

For the introduction of the workpieces, of course, it is necessary for the punch 16, together with its guide piston 18, to be forced upwards counter to the force of the spring 26.

The upwardly and downwardly oscillating striking mass 40 with the air column or a striker spring of a pneumatic drive may constitute a vibratory system which is operated outside its resonant frequency, preferably far below its resonant frequency. This is because the subassembly comprising the extension 22 and C-shaped frame then remains largely at a standstill, with the result that the unit can easily be guided by hand.

In the case of the method according to the invention, joining is brought about by means of a single stroke of the punch 16, the latter executing said stroke in a plurality of discrete steps.

According to a development of the joining unit according to FIG. 1 which is not illustrated, the mount of the punch and die may be in the form of tongs. It is also possible to provide a force deflection via a slanting plane. Also conceivable are installations with a plurality or multiplicity of sets of joining tools, in the case of which a single, large, joint counteracting mass is provided behind the dies.

Accordingly, an apparatus according to the invention for mechanically joining sheet-metal parts has a tool set comprising at least one punch 16 and an anvil-containing die 14 as the tool-set elements, between which the metal sheets 30 which are to be connected lie flat one upon the other, it being the case that at least one tool-set element 16 or 14 can be displaced in order to subject the sheet-metal parts 30 to deformation energy, and the displaceable tool element is designed as a striking tool with a moving mass 40 by means of which impact stressing in the form of a series of blows of short duration can be introduced into the sheet-metal parts 30.

FIG. 2 shows a second exemplary embodiment of a joining unit, the only difference from that described with reference to FIG. 1 being that the positions of the die 14 and punch 16 have been changed round. In this case, the striking mass 40 thus acts on the die 14, while the punch 16 is clamped in a stationary manner. In other respects, the information which has been given above with reference to FIG. 1 applies correspondingly.

In design terms, it may additionally be provided that the striking mass 40 is accelerated electromechanically or pneumatically or via an arrangement which executes a periodic movement up and down in an axial direction. It is also possible to use the ignition of an explosive. The different drive means all permit impact joining according to the invention. In the case of the two exemplary embodiments illustrated, it is additionally possible for the tool element which is not designed as a striking tool also to be designed such that it can be moved in relation to the striking tool. In the case of the embodiment according to FIG. 1, it is then additionally possible for the die 14 to be moved towards the punch 16.

Finally, the joining unit according to the invention may be designed with a long projecting length. This means that, for example, the bottom leg 10 according to FIG. 1 may be designed as a long-limbed, single-armed lever which extends from the C-bracket 12. The same, of course, applies to the leg which bears the associated punch 16.

In the case of a method according to the invention of mechanically joining sheet-metal parts, in the case of which, by means of a tool set comprising at least one punch and an anvil-containing die, sheet-metal material is jointly displaced out of a sheet-metal plane, and upset, under the action of deformation energy, it is accordingly provided that the deformation energy or deformation work is produced by impact stressing in the form of a series of blows of short duration. The reaction forces may be absorbed by a counteracting mass arranged on that side of the tool set which is directed away from the striking mass. The magnitude of the impulses may be such that the deformation energy fed per impulse causes a relatively small amount of plastic deformation of the materials which are to be joined.

The series of individual blows, the number of blows and the duration of the blows may be selected as has been described above for the joining units in conjunction with FIGS. 1 and 2. Furthermore, impact work absorbed by the metal sheets 30 per blow as a result of the impact stressing may preferably be in the range from 7 to 20 joules.

Moreover, during joining, an auxiliary joining part may be incorporated in the joining operation. Examples of auxiliary joining parts are punch rivets, in particular those with a semitubular rivet, which remain in the joining zone.

In other respects, you are referred to the description of the joining units according to FIGS. 1 and 2.

1. Method of mechanically joining sheet-metal parts, in the case of which, by means of a tool set comprising at least one punch and an anvil-containing die, sheet-metal material is jointly displaced out of a sheet-metal plane, and upset, under the action of deformation energy, characterized in that the deformation energy is produced by impact stressing in the form of a series of blows of short duration.

2. Method according to claim 1, characterized in that the duration of the blows is short enough not to essentially overcome the inertia of a counteracting mass, which is assigned to a moving mass, from being overcome.

3. Method according to claim 1 and 2, characterized in that a moving mass produces blows in quick succession.

4. Method according to one of claims 1 to 3, characterized in that the impact stressing is produced by a number of blows amounting to from 10 to 50 blows per second.

5. Method according to one of claims 1 to 4, characterized in that the duration of one blow is selected to be in the range between 0.02 and 5 ms.

6. Method according to one of claims 1 to 5, characterized in that impact work absorbed by the sheet-metal parts per blow as a result of the impact stressing is in the range from 7-20 joules.

7. Method according to one of claims 1 to 6, characterized in that the impact stressing is transmitted via an auxiliary joining part which is incorporated in a joining operation and remains in a joining zone.

8. Method according to one of claims 1 to 7, characterized in that the impact stressing is produced by an electromechanically accelerated mass.

9. Method according to one of claims 1 to 7, characterized in that the impact stressing is produced by a pneumatically accelerated mass.

10. Method according to one of claims 1 to 7, characterized in that the impact stressing is produced via a moving mass which is accelerated via an arrangement which executes a periodic movement up and down in an axial direction.

11. Method according to one of claims 1 to 10, characterized in that the impact stressing is introduced via the punch.

12. Method according to one of claims 1 to 10, characterized in that the impact stressing is introduced via the die.

13. Method according to one of claims 1 to 12, characterized in that the impact stressing is produced by a moving mass which is accelerated by the ignition of an explosive.

14. Method according to one of claims 1 to 13, characterized in that the impact stressing is produced by a moving mass as part of a vibratory system which is operated outside its resonant frequency.

15. Apparatus for mechanically joining sheet-metal parts, having a tool set comprising at least one punch and an anvil-containing die as the tool-set elements, between which the metal sheets which are to be connected lie flat one upon the other, it being the case that at least one tool-set element can be displaced in order to subject the sheet-metal parts to deformation energy, characterized in that the displaceable tool element is designed as a striking tool with a moving mass (40) by means of which impact stressing in the form of a series of blows of short duration can be introduced into the sheet-metal parts (30).

16. Apparatus according to claim 15, characterized in that the moving striking mass (40) is formed by a free-floating piston which is guided in a cylinder-like rectilinear guide (38) assigned to the displaceable tool-set element.

17. Apparatus according to claim 16, characterized in that the two sides of the piston are subjected alternately and in quick succession to the action of compressed air.

18. Apparatus according to one of claims 15 to 17, characterized in that the striking tool is formed by the punch (16), opposite which the die (14) is clamped in a stationary manner in a die mount.

19. Apparatus according to claim 18, characterized in that the die (14) can additionally be moved towards the punch (16).

20. Apparatus according to one of claims 15 to 19, characterized in that the punch (19) is guided rectilinearly in a punch mount, which is aligned with a rectilinear guide (38) for the striking mass (40).

21. Apparatus according to claim 20, characterized in that the punch mount is secured against rotation.

22. Apparatus according to one of claims 15 to 21, characterized in that the punch (16) is assigned a spring arrangement (26) which prestresses the punch (16) against the sheet-metal parts (30) at the beginning of the joining operation.

23. Apparatus according to one of claims 15 to 22, characterized in that the punch (16) is assigned a displacement-limiting means.

24. Apparatus according to one of claims 15 to 17, characterized in that the striking tool is formed by the die (14), opposite which the punch (16) is clamped in a stationary manner.

25. Apparatus according to one of claims 15 to 24, characterized in that there is provided a C-shaped frame (12), in one leg (10) of which the die (14) is retained and in the other leg of which the punch mount is guided.

26. Apparatus according to claim 25, characterized in that the legs (10) may each be designed as long-limbed, single-armed levers, of which the free ends each bear a punch (16) or die (14).

27. Apparatus according to one of claims 15 to 24, characterized in that the tool set may be formed on a tong structure.
